(19) United States
(12) Patent Application Publication
(10) Pub. No.: US 2012/0175220 A1
(43) Pub. Date: Jul. 12, 2012

(54) ESCALATOR DISPLAY DEVICE

(76) Inventors: Nakamori Masanori, Kanawaga (JP); Ogata Sho, Kanagawa (JP)

(21) Appl. No.: 13/351,051

(22) Filed: Jan. 16, 2012

Related U.S. Application Data
(63) Continuation of application No. 12/279,008, filed on Aug. 11, 2008, now abandoned.

(30) Foreign Application Priority Data
Feb. 23, 2006 (JP) 2006-046102

(51) Int. Cl. B66B 25/00; B66B 23/24; G09F 13/18

(52) U.S. Cl. 198/322; 40/581; 198/335

(57) ABSTRACT

An escalator display device includes a light-emitting body arranged on an edge of a side wall, which includes a transparent medium. The light-emitting body is arranged to display a displayed item on the surface of the transparent medium and is a photosensitive material that reacts photosensitively with the light emission color of the light-emitting body.

### CROSS-REFERENCE TO RELATED APPLICATIONS

This application is a continuation of U.S. patent application Ser. No. 12/279,008 filed Aug. 11, 2008.

### TECHNICAL FIELD

The present invention relates to an escalator display device that can display images on an escalator side wall.

### BACKGROUND SECTION

In the past, liquid-crystal panels, for example, have been used as display devices for display on side panels, for example, transparent panels (glass, acrylic, etc.) at the handrails of an escalator, furnished on both sides along the path of the escalator steps (treads). However, such displays require backlighting, which is expensive. In addition, when light bulbs or LEDs (light-emitting diodes) are used as the display device, they cannot be embedded in a transparent panel made of glass, acrylic or the like, or even if they could, the wiring, etc. would be visible to the rider, which is very unattractive.

Japanese Kokai Patent Application No. 2005-82400 illustrates a device that displays images on the handrail and side surfaces of an escalator.

### SUMMARY OF THE INVENTION

Exemplary embodiments include an escalator display device includes a light-emitting body arranged on an edge of a side wall, which includes a transparent medium. The light-emitting body is arranged to display a displayed item on the surface of the transparent medium and is a photosensitive material that reacts photosensitively with the light emission color of the light-emitting body.

### BRIEF DESCRIPTION OF THE DRAWINGS

FIG. 1 is an overall block diagram of one embodiment of the present invention.

FIG. 2 represents one embodiment of the present invention. FIG. 2(a) is an overall block diagram for a red display, 2(b) is a front view of the main parts, and 2(c) is a side view of the main parts.

FIG. 3 represents one embodiment of the present invention. FIG. 3(a) is an overall block diagram for a green display, 3(b) is a front view of the main parts, and 3(c) is a side view of the main parts.

FIG. 4 represents another embodiment of the present invention. FIG. 4(a) is an overall block diagram of an up escalator and 4(b) is an overall block diagram of a down escalator.

### DETAILED DESCRIPTION

Below, an exemplary embodiment of the present invention will be explained with reference to the figures; however, the present invention is not limited to the embodiment below. FIG. 1 shows the side surface of the boarding location at the bottom of an escalator 10. The escalator 10 includes a handrail side panel 12 with a transparent medium, a plurality of steps 14, and a handrail 16. The transparent medium includes a material that is transparent, including glass or acrylic.

The escalator 10 has a display device 18 that has a plurality of red LEDs 20R and green LEDs 20G as light-emitting bodies are arranged on the peripheral edge below the handrail side panel 12. Displayed items 22, such as the words “Please watch your step” and an arrow pointing to the position where steps 14 emerge, are printed with a paint of a long-wavelength color (red) and additional displayed items, such as the words “Please do not walk on the escalator,” is printed with a paint of a short-wavelength color (green) on the surface of handrail side panel 12 toward steps 14.

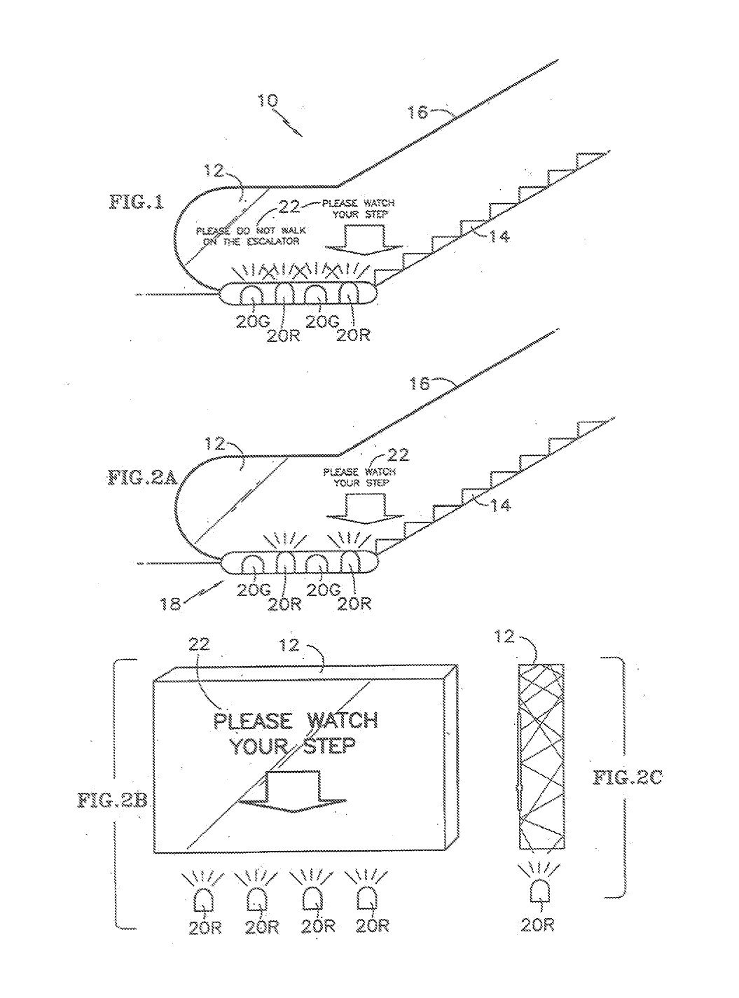

FIG. 2 represents when red LEDs 20R are lighted. FIG. 2(a) shows the side surface of the boarding location at the bottom of the escalator 10, FIG. 2(b) shows the constitution of the front surface of handrail side panel 12 and FIG. 2(c) shows the constitution of the side surface of handrail side panel 12.

In FIG. 2, red LEDs 20R are arranged at a prescribed spacing at the peripheral edge at the bottom of handrail side panel 12 or near it. When red LEDs 20R are turned on, red light is reflected while being transmitted through handrail side panel 12, the paint reflects light in response to red wavelengths, and an arrow indicating the positions where steps 14 emerge and the words “Please watch your step” can be displayed.

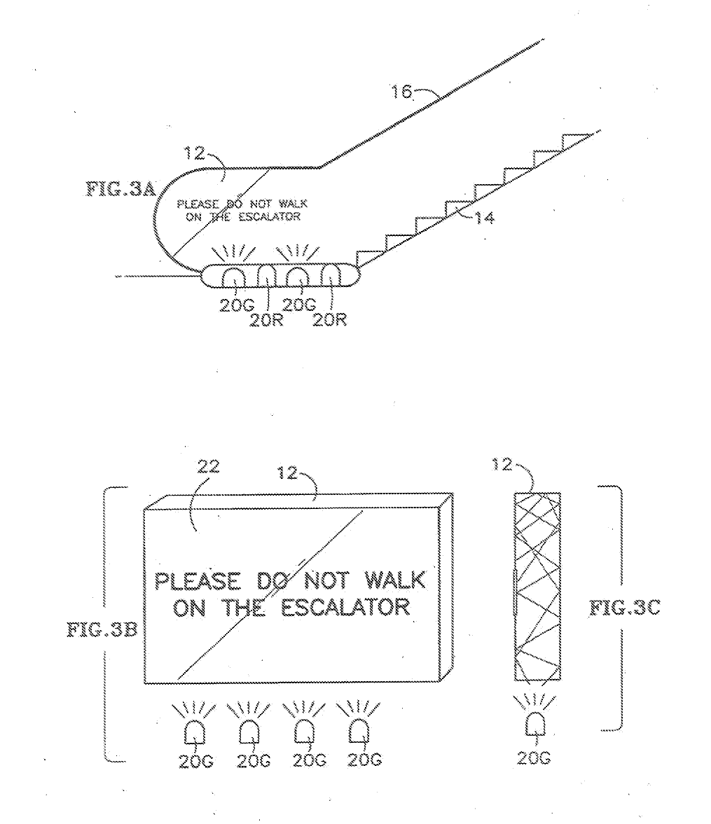

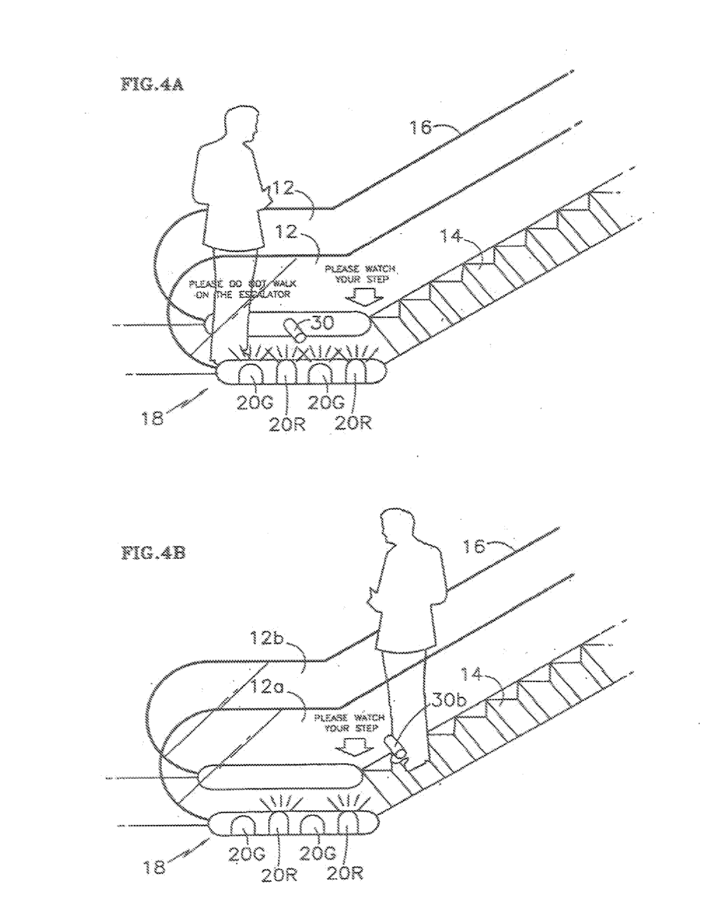

FIG. 3 represents when green LEDs 20G are turned on. FIG. 3(a) shows the side surface of the boarding location at the bottom of the escalator 10, FIG. 3(b) shows the constitution of the front surface of handrail side panel 12, and FIG. 3(c) shows the constitution of the side surface of handrail side panel 12.

In FIG. 3, green LEDs 20G are arranged at a prescribed spacing at the peripheral edge at the bottom of handrail side panel 12 or near it. When green LEDs 20G are turned, green light on is reflected while being transmitted through handrail side panel 12, the paint reflects light in response to red wavelengths, and the words “Please do not walk on the escalator” can be displayed.

Additionally, when red LEDs 20R and green LEDs 20G are both turned on, the words “Please watch your step” and the arrows emitting red light and the words “Please do not walk on the escalator” emitting green light can both be displayed as in FIG. 1.

While the embodiment has been illustrated with the use of specific words and arrows, it is understood that any type of displayed item could be printed on the handrail side panel. In addition, the displayed items 22 are not limited to being printed with the above-mentioned paint on the surface of handrail side panel 12. Red and green photosensitive films on which words or arrows can be formed with paint that reacts photosensitively to red or green could also be adhered to the surface of handrail side panel 12.

Because displayed items, such as words such as “Please watch your step” or “Please do not walk on the escalator,” or an arrow or the like, can be displayed floating on the side panel in the handrail portion of the escalator in this way, riders can be provided with warnings.

Red LEDs 20R and green LEDs 20G are furnished at a location on the peripheral edge of handrail side panel 12, below it, for example, so that no elements are installed in the direction of the thickness of handrail side panel 12, the appearance is not marred, and neither the wiring or the LED elements are visible to riders, so that it is outstanding in terms of design.

FIG. 4 is an embodiment with which the displayed items are displayed by emitted light when a rider is detected by a people sensor 30. As shown in FIG. 4(a), the people sensor 30 can be located at the entrance of the escalator 10, before the steps 14. As shown in FIG. 4(b), the people sensor 30b can also be located at a set distance from the entrance and a set distance up the steps 14, so that rider coming down the steps 14 will activate the lights before exiting the escalator 10. In addition, there can be two people sensors 30, 30b located on the escalator 10 so that the lighting is activated when a person enters the escalator 10 or before a person exits the escalator 10. When the people sensor 30, 30b detects a rider, red LEDs 20R and green LEDs 200 furnished below handrail side panel 12a in the same way as for the handrail side panel 12, turn on, and the words, e.g., “Please watch your step” and “Please do not walk on the escalator,” printed on the surface of handrail side panel 12a (toward steps 14), and arrows pointing to where steps 14 emerge are displayed.

The advantages of the display device 18 are that the display device can be made thinner and miniaturized. Backlighting or the like is also not necessary, and it can be constituted inexpensively. In addition, by printing, for example, a photosensitive material (light-emitting paint) on the surface of the transparent medium, the displayed item can easily be provided. Thus, the tedious operation of cutting into the surface of the transparent medium, e.g., glass or acrylic, is obviated.

The displayed items 22 are not limited to words and arrows and could also be other symbols, pictures, etc. In addition, the displayed items could include guides to individual floors, messages, advertising, etc.

This application claims priority to Japanese application 2006-046102, which was filed on Feb. 23, 2006, and is herein incorporated by reference in its entirety.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1-5. (canceled)

6. An escalator display device comprising:
a light-emitting body arranged on an edge of a side wall of a handrail side panel engaged with a handrail of the escalator, the side wall includes a transparent medium, and the light-emitting body is arranged to display a displayed item on a surface of the transparent medium, the displayed item comprising a photosensitive material that reacts photosensitively with a light emission color of the light-emitting body.

7. The escalator display device of claim 6, further comprising a people sensor installed in proximity to the displayed item, the people sensor is configured to provide an indication to cause the light-emitting body to emit light when the people sensor detects the presence of a person.

8. The escalator display device of claim 6, wherein the light-emitting body is a multicolor light-emitting body, and the displayed item is photosensitive material that reacts photosensitively with each of the light emission colors of the multicolor light-emitting body.

9. The escalator display device Of claim 6, wherein the displayed item includes pictures, words, and symbols printed with a light-emitting paint.

10. The escalator display device of claim 6, wherein the photosensitive material only displays the displayed item when a selected color of light emanates from the light-emitting body and does not display the displayed item responsive to another, different color of light emanated from the light-emitting body.

11. The escalator display device of claim 6, wherein the displayed item comprises a plurality of items, at least one of the items displaying only one of a plurality of colors produced by the light-emitting body and another one of the items displaying only a second, different one of the colors produced by the light-emitting body.

12. The escalator display device of claim 6, wherein the photosensitive material comprises paint or a film.

13. The escalator display device of claim 6, wherein the portion of the sidewall that includes the displayed item is illuminated when the photosensitive material reacts to light from the light-emitting body.

14. The escalator display device of claim 6, wherein the light-emitting body comprises light-emitting diodes.

15. An escalator comprising:
a handrail;
a plurality of steps arranged adjacent to a handrail side panel engaged with the handrail, the handrail side panel having a transparent medium, and a display device arranged on an edge of the handrail side panel, the display device includes a light-emitting body that is arranged to display a displayed item on a surface of the transparent medium, the displayed item comprising a photosensitive material that reacts photosensitively with a light emission color of the light-emitting body.

16. The escalator of claim 15, including a people sensor installed in proximity to the displayed item, the light-emitting body emitting light responsive to the people sensor detecting the presence of a person.

17. The escalator of claim 15, wherein the light-emitting body is a multi-color light-emitting body, and the displayed item is photosensitive material that reacts photosensitively with each of the light emission colors of the multi-color light-emitting body.

18. The escalator of claim 15, wherein the displayed item includes pictures, words and symbols printed with a light-emitting paint.

19. The escalator of claim 15, wherein the light-emitting body comprises light-emitting diodes.

20. The escalator of claim 15, wherein the portion of the side panel that includes the displayed item is illuminated when the photosensitive material reacts to light from the light-emitting body.

21. The escalator of claim 15, wherein the photosensitive material comprises paint.

22. The escalator of claim 15, wherein the photosensitive material comprises a film.

23. The escalator of claim 15, wherein the photosensitive material only displays the displayed item when a selected color of light emanates from the light-emitting body and does not display the displayed item responsive to another, different color of light emanated from the light-emitting body.

24. The escalator of claim 15, wherein the light-emitting body comprise a plurality of distinct light sources that each produces one of a plurality of colors and wherein the light sources are selectively controlled to control a content of the displayed item responsive to one or more selected colors of light that emanates from the light-emitting body.

25. The escalator of claim 15, wherein the displayed item comprises a plurality of items, at least one of the items displaying only one of a plurality of colors produced by the light-emitting body and another one of the items displaying only a second, different one of the colors produced by the light-emitting body.
